(19) United States
(12) Patent Application Publication
(10) Pub. No.: US 2011/0200488 A1
(43) Pub. Date: Aug. 18, 2011

(54) MODULAR FRAGRANCE APPARATUS

(75) Inventors: Giovanni Cennini, Eindhoven (NL); Pieter Jacob Snijder, Valkenswaard (NL); Dmitri Chestakov, Eindhoven (NL)

(73) Assignee: KONINKLIJKE PHILIPS ELECTRONICS N.V., EINDHOVEN (NL)

(21) Appl. No.: 13/125,052

(22) PCT Filed: Oct. 14, 2009
(86) PCT No.: PCT/IB2009/054508

§ 371 Date: Apr. 20, 2011

(30) Foreign Application Priority Data
Oct. 24, 2008 (EP) 08167511.8

(51) Int. Cl. B01J 19/00

(52) U.S. Cl. 422/105; 422/123

(57) ABSTRACT

A fragrance apparatus comprising a fragrance dispensing unit having a plurality of fragrance dispensers being refillable, the fragrance dispensing unit being disposed in a modular housing unit and a control unit disposed in the modular housing unit, the control unit configured to control the fragrance apparatus such that the fragrance dispensing unit generates a spatio-temporal pattern of fragrance and/or removes the generated spatio-temporal pattern of fragrance is disclosed. The disclosed fragrance apparatus is useful in atmosphere creation.

### FIELD OF THE INVENTION

The present subject matter relates to a modular fragrance apparatus.

### BACKGROUND OF THE INVENTION

Patent document US2005/0185392 discloses an apparatus for producing combined presentation of light and aroma to produce an overall sensory effect. The disclosed apparatus has limited modularity. Further, the spectrum of fragrances that can be delivered by the disclosed apparatus is limited.

Hence, it would be advantageous to have a fragrance apparatus that is modular and allows the creation of a broad spectrum of fragrances.

### SUMMARY OF THE INVENTION

Accordingly, the present subject matter preferably seeks to mitigate, alleviate or eliminate one or more of the above mentioned disadvantages singly or in combination. In particular, it may be seen as an object of the present subject matter to provide a fragrance apparatus that is modular and allows creation of a broad spectrum of fragrances.

This object and several other objects are obtained in a first aspect of the present subject matter by providing a fragrance apparatus comprising

a fragrance dispensing unit having a plurality of fragrance dispensers being refillable, the fragrance dispensing unit being disposed in a modular housing unit; and

a control unit disposed in the modular housing unit, the control unit configured to control the fragrance apparatus such that the fragrance dispensing unit generates a spatio-temporal pattern of fragrance and/or removes the generated spatio-temporal pattern of fragrance.

The disclosed apparatus has a plurality of fragrance dispensing units that can be configured and controlled to generate a spatio-temporal pattern of fragrance. Each fragrance dispensing unit can have a set of fragrances (at least one fragrance). Further, the control unit can control the fragrance apparatus such that it delivers fragrances that can change in time and space. This allows creation of spatio-temporal fragrance and can enhance the experience of the user.

US document 2005/0185392 discloses an apparatus for coordinated emission of fragrance, light and sound. The spectrum of fragrance that is emitted is limited. On the other hand, in the disclosed fragrance apparatus the composition of the delivered fragrance can be suitably controlled by controlling the amount of perfume emitted from each of the fragrance dispensing unit. As an illustrative example, X % of perfume from fragrance dispenser 1, Y % of perfume from fragrance dispenser 2, Z % of perfume from fragrance dispenser 3 can be combined thereby creating a broader spectrum of fragrance.

The plurality of fragrance dispensing units can be controlled to emit fragrance that varies in time and space so that different effects are produced in different parts of an enclosed area. Further, by suitably controlling the amount of perfume to be emitted from each of the fragrance dispensing unit the aroma can be varied.

The disclosed fragrance apparatus can not only deliver the fragrance but also remove the delivered fragrance. The fragrances can be absorbed by passive or active filters that are present in the fragrance dispensers. There can be a set of ventilators (to suck the air and fragrances inside) and active filters. Another possibility is represented by light: with light it would be possible in principle to break the perfume molecules. Further, other fragrance dispensing units can emit some anti-fragrances: fragrance that cover or mitigate the fragrances emitted by fragrance dispensing units.

The disclosed fragrance apparatus is modular. Modular here refers to the fragrance apparatus constructed with standardized units or dimensions allowing flexibility and variety in use. It is possible to put together several units easily. The interconnection among the modular units can be mechanical, electrical, optical and/or magnetic.

The spatio-temporal fragrance atmosphere created using the disclosed fragrance controller can be made to appear more natural and not artificial.

In an embodiment, a plurality of modular housing units are operatively interconnected and configured such that the plurality of control units communicate with each other, exchange data with each other and operate in mutual synchronization to generate a spatio-temporal pattern of substantially broad spectrum of fragrances.

The disclosed fragrance apparatus can have inbuilt intelligence. Each fragrance apparatus can be a stand alone unit and several fragrance apparatus can be easily put together and operatively interconnected due to its modular feature. The control units can be configured to communicate with each other, exchange data with each other and operate in mutual synchronization to generate a substantially broad spectrum of fragrances. Spectrum of fragrance here refers to range of related fragrances that can be obtained by combining various quantities of perfumes in a particular composition. Intelligence can be built in so that the control unit can adjust the composition of various perfumes from the plurality of fragrance dispensers and generate a substantially broad spectrum of fragrance.

The disclosed fragrance apparatus can have intelligent features such as

i. additivity

ii. mutual integrability or synchronization

The perfumes from the plurality of fragrance dispensers can be added appropriately to obtain a desired fragrance. Further, the plurality of fragrance dispensers can be controlled to work in synchronization to generate a spatio-temporal pattern of broad spectrum of fragrances.

In a further embodiment, in operation a state of a first modular housing unit depends on a state of at least one second modular housing unit, the state being the state of the control unit.

In some embodiments, micro-holes can be disposed preferably on the front plane, the back plane and the side plane of each of the modular housing unit. The micro-holes allow:

i. a release in air of the fluid contained in the fragrance dispensers

ii. an absorption of the perfume (and or dust) for air-cleaning

iii. cooling

In some embodiments, the fragrance dispensing unit can be activated by an actuator, the actuator action being based on at least one of
electric field
magnetic field
mechanical field
thermal field
optic field
   The fragrance dispensing unit can be activated by electronic signals via actuators. The actuator action can be the result of presence detection on the basis of an electric, magnetic, mechanical, thermal field or light field. As an illustrative example, a piezo frequency generator can adjust the rate at which the fragrance is dispensed thus controlling the potency of the aroma.

In a still further embodiment, the plurality of modular housing units are operatively interconnected such that the plurality of control units cooperate under control of a central controller or a computer, communicate with the central controller, operate in mutual synchronization to generate the spatio-temporal pattern of substantially broad spectrum of fragrances.

In some embodiments, the fragrance apparatus comprises a plurality of air filters disposed inside each of the modular housing unit. The air filters can help in cleaning.

The air filters may have to be replaced from time to time when they saturate because of perfume molecules or air pollutants. It is also possible to use electro chemical filters whose action can be restored, for example, when a voltage is applied or a chemical agent is added. Alternately the air filters can be placed on a separate plane from the modular housing unit. It is also possible to dispose an air pump system behind the modular housing unit to replace the scenting air with fresh one.

In a still further embodiment, the fragrance apparatus further comprises

a presence sensor disposed on each of the modular housing unit, the presence sensor configured to detect the presence of a person;

a proximity sensor disposed on each of the modular housing unit, the proximity sensor configured to estimate the distance between the fragrance apparatus and the person; and

the plurality of controls unit further adapted to generate the spatio-temporal pattern of substantially broad spectrum of fragrance if the estimated distance is less than a predetermined value. As an illustrative example, the fragrance apparatus can be configured to deliver perfumes only if the distance between the person and the fragrance apparatus is between X cms and Y cms. This can optimize the use of the fragrance apparatus and save on perfume. Further, it can help in creating the desired fragrance atmosphere only when required.

In a still further embodiment, the fragrance apparatus further comprises

at least one lighting unit disposed on each of the modular housing unit, the at least one lighting unit comprising at least one light source controllable by a processor for generating radiation of one or more color and/or one or more brightness levels; and

the plurality of control units further adapted to generate a spatio-temporal correlation between light patterns and fragrances. Generally, the lighting of an environment has a significant effect on the ambience associated with the environment. Environments conducive to reading are typically brightly lit; environments conducive to romance are typically dimly lit; and so on. In addition to the luminance level, the chromatic content also affects the ambience of the environment. A yellow or red tinted light is generally considered to be “warmer” than a blue tinted light. Similarly, the saturation (white content) of the light and other parameters, such as the degree of dispersion of the light, will generally affect the ambience. This embodiment can allow combining light effects and fragrances and can generate spatio-temporal correlation between light patterns and fragrances thereby enhancing the user experience. The dynamical effects can prevent the saturation of perception.

In a still further embodiment, the fragrance apparatus further comprises

a plurality of photo sensors disposed on each of the modular housing unit configured to detect the level of ambient light in the vicinity of the fragrance apparatus; and

the plurality of control units further adapted to generate the spatio-temporal correlation between light patterns and fragrances based on the detected level of the ambient light. The atmosphere can be dynamically adjusted based on the detected ambient light. This can create relaxing, exciting, calming and seducing atmospheres.

In a still further embodiment, the fragrance apparatus further comprises

a plurality of color sensors disposed on each of the modular housing unit configured to detect a plurality of colors and/or a combination of colors and distinguish the detected plurality of colors; and

the plurality of control units further adapted to generate the spatio-temporal correlation between light patterns and fragrances based on the detected plurality of colors and/or the combination of the detected colors.

In a still further embodiment, a state of a first modular housing unit depends on a state of at least one second modular housing unit, the state being the state of the control unit representing a combination of fragrance and light. The control unit can coordinate to adjust the light effects and the fragrance dispersal and vice-versa, thereby simplifying the process of achieving a desired fragrance ambience.

In a still further embodiment, the fragrance apparatus further comprises

at least one acoustic generator unit disposed on each of the modular housing unit, the at least one acoustic generator unit comprising at least one acoustic source controllable by a processor for generating sound; and

the plurality of control units further adapted to generate a spatio-temporal correlation between light patterns, sound and fragrances. This embodiment allows the modular housing units to communicate with each other, exchange data with each other and coordinate with each other to generate spatio-temporal correlation between light patterns and fragrances. This can enhance the user experience.

In some embodiments, the fragrance apparatus can further comprise

at least one acoustic sensor disposed on each of the modular housing unit configured to detect a plurality of sounds and/or a combination of sounds and distinguish the detected plurality of sounds and/or the combination of detected sounds; and

the plurality of control units further adapted to generate the spatio-temporal correlation between light patterns, fragrances and sound based on the detected plurality of sounds and/or the combination of detected sounds.

In a still further embodiment, a state of the first modular housing unit depends on a state of at least one second modular housing unit, the state being the state of the control unit representing a combination of fragrance, light and sound. This embodiment allows the modular housing units to communicate with each other, exchange data with each other and coordinate with each other to generate spatio-temporal correlation between light patterns, fragrance and sound.

In a still further embodiment, the plurality of modular housing units can be preferably square/rectangle in shape and can be put together to form a fragrant tile, the fragrant tile being disposed on the wall of an enclosed area, preferably a room. It is possible to put together several modular housing units together. Each of the modular housing unit can contain a plurality of fragrance dispensers, a plurality of light units and a plurality of acoustic generators. Each modular housing unit can be self sufficient and a combination of modules can cover a wall and can be configured to create a suitable atmosphere. It is possible to combine light effects and fragrances. One possible implementation can be in the form of intelligent fragrant tiles. These tiles may be augmented with sound. The modular housing units can have a square shape and arranged to form a wall. The modules can be configured to emit light such that a global pattern is recognized at a higher level. If the fragrances are synchronously emitted from each modular housing unit, according to a specific algorithm, or communication among the other modular housing units, then it is possible to create a spatio-temporal correlation between light patterns, sound and delivered fragrances. It can be shown that the level of attention in people when watching a movie or listening to music voices can be greatly increased when some fragrances are presented. However, the fragrances should have a (logical, emotional) relation with the presented content and should not persist long in time.

It is also possible to create a spatio-temporal fragrance image of an object (e.g. an image of a flower) along the wall of a room in combination with sound patterns. This can further enhance the user experience. If we imagine having a set of tiles to display an image and if the emission of fragrances occurs at low pressure as a slow diffusion process, then one can imagine that at short distances (near the tiles), the fragrances will be localized in space near the tiles that emitted them. This would result in a fragrance spatial map of the image displayed by the tiles. At larger distances, one can have a combination of different fragrances.

### BRIEF DESCRIPTION OF THE DRAWINGS

These and other aspects, features and advantages will be further explained by the following description, by way of example only, with reference to the accompanying drawings, in which same reference numerals indicate same or similar parts, and in which:

FIG. 1 schematically illustrates an exemplary fragrance apparatus according to an embodiment of the present subject matter;

FIG. 2 schematically illustrates an exemplary fragrance apparatus according to a further embodiment of the present subject matter;

FIGS. 3-10 schematically illustrates exemplary embodiments of the fragrance apparatus according to the present subject matter; and

FIG. 11 schematically illustrates an exemplary embodiment of the fragrance apparatus in the form of a fragrant tile disposed on the wall of an enclosed area.

### DETAILED DESCRIPTION OF THE EMBODIMENTS

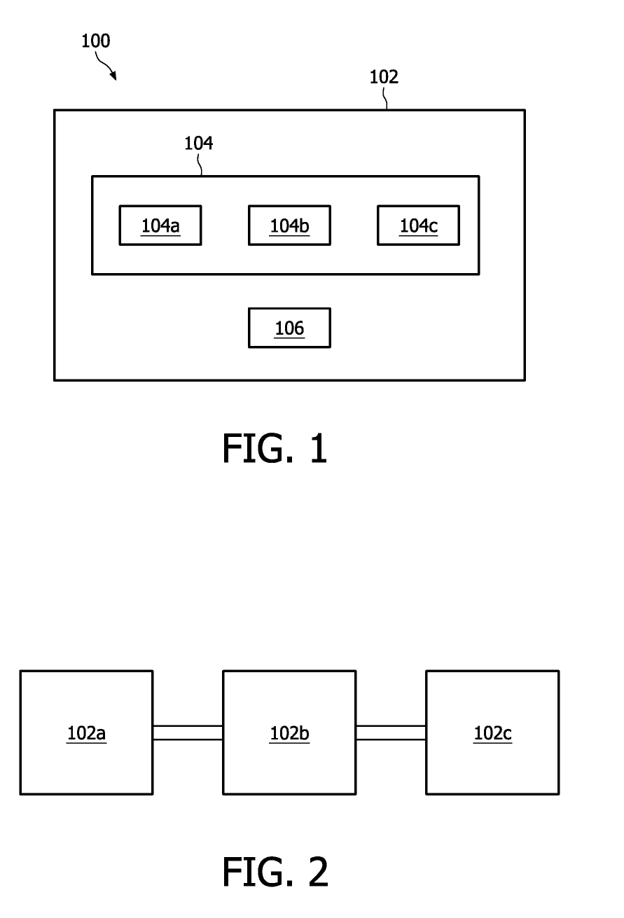

Referring now to FIG. 1, the fragrance apparatus 100 comprises
1. a modular housing unit 102
2. a fragrance dispensing unit 104 comprising a plurality of fragrance dispensers 104a, 104b, 104c
3. a control unit 106
   The plurality of fragrance dispensers 104a, 104b, 104c may hold a perfume in any one of a number of conventional forms, including gel and liquid forms. The fragrance dispenser can be activated by an actuator and the fragrance can be vaporized and ejected outside. The actuator action can be based on at least one of electric field, magnetic field, mechanical field, thermal field and optic field. The control unit 106 can be implemented in hardware or in software. The control unit 106 can be configured to control the fragrance apparatus 100 such that the fragrance dispensing unit 104 generates a spatio-temporal pattern of fragrance and/or removes the generated spatio-temporal pattern of fragrance.

Referring now to FIG. 2, a plurality of modular housing units 102a, 102b, 102c can be operatively interconnected and configured such that the plurality of control units 106a, 106b, 106c communicate with each other (using wired or wireless communication), exchange data with each other (using known communication protocols) and operate in mutual synchronization to generate a spatio-temporal pattern of substantially broad spectrum of fragrances. It is possible to create a spatial pattern of fragrances which can “move” i.e. can change its spatial distribution during time.

The disclosed fragrance apparatus can have inbuilt intelligence. Each fragrance apparatus can be a stand alone unit and several fragrance apparatus can be easily put together and operatively interconnected due to its modular feature. The control units can be configured to communicate with each other, exchange data with each other and operate in mutual synchronization to generate a substantially broad spectrum of fragrances. Spectrum of fragrance here refers to range of related fragrances that can be obtained by combining various quantities of perfumes in a particular composition. Intelligence can be built in so that the control unit can adjust the composition of various perfumes from the plurality of fragrance dispensers and generate a substantially broad spectrum of fragrance.

The disclosed fragrance apparatus can have intelligent features such as

i. additivity

ii. mutual integrability or synchronization

The perfumes from the plurality of fragrance dispensers can be added appropriately to obtain a desired fragrance. Further, the plurality of fragrance dispensers can be controlled to work in synchronization to generate a spatio-temporal pattern of broad spectrum of fragrances.

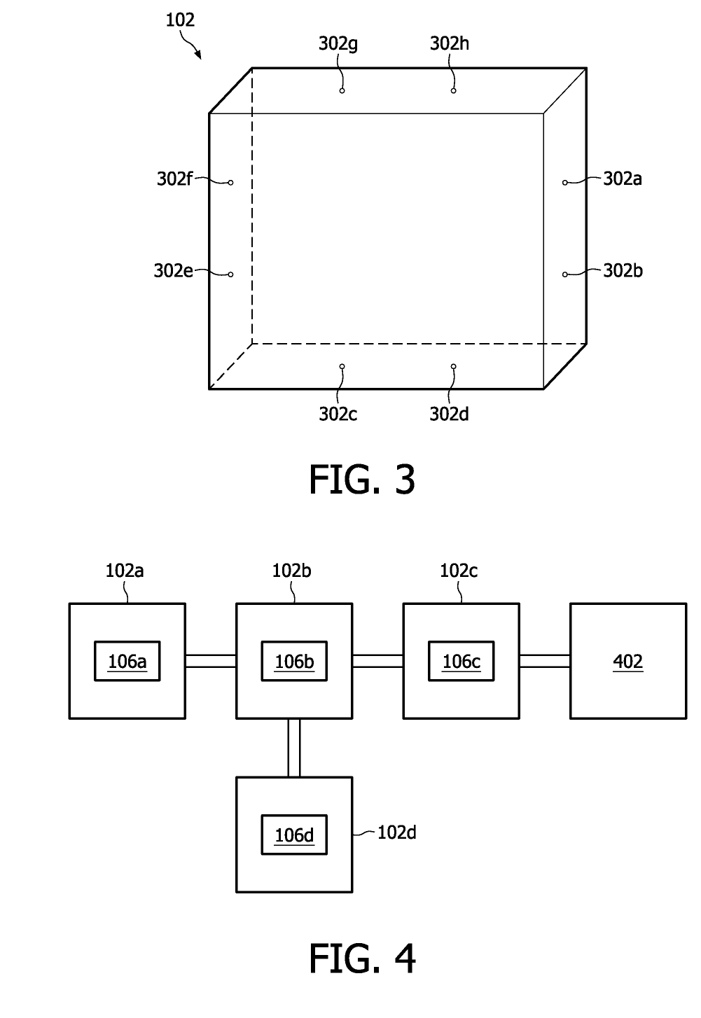

Referring now to FIG. 3, a plurality of micro-holes 302a, 302b, 302c, 302d, 302e, 302f, 302g, 302h can be disposed preferably on the front plane, the back plane and the side plane of each of the modular housing unit. The micro-holes allow:

i. a release in air of the fluid contained in the fragrance dispensers

ii. an absorption of the perfume (and or dust) for air-cleaning

iii. cooling

Referring now to FIG. 4, the plurality of modular housing units 102a, 102b, 102c, 102d can be operatively interconnected such that the plurality of control units 106a, 106b, 106c, 106d cooperate under control of a central controller or a computer 402, communicate with the external central controller, operate in mutual synchronization with the central controller to generate the spatio-temporal pattern of substantially broad spectrum of fragrances.

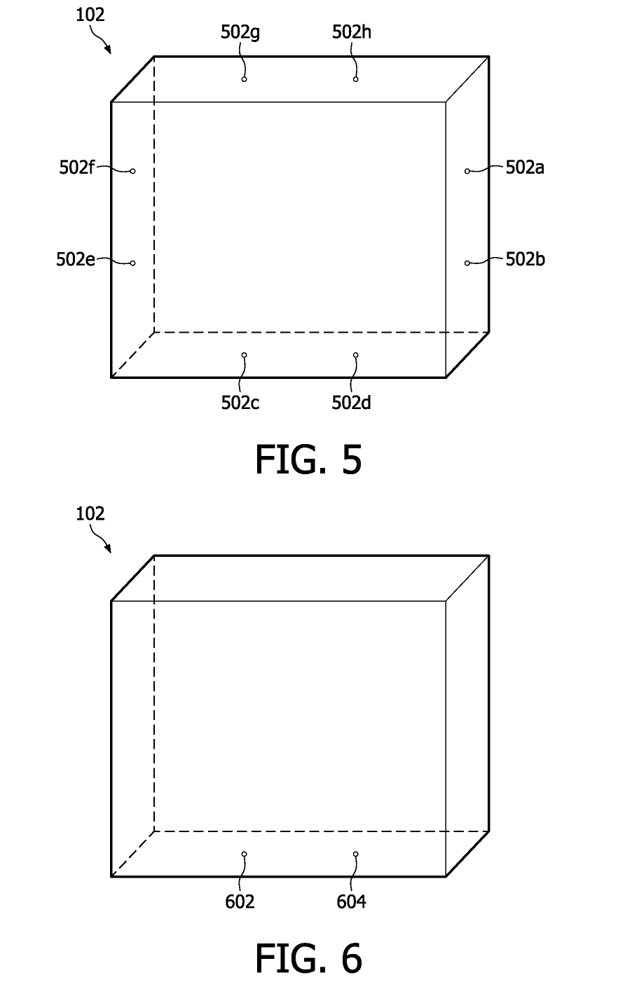

Referring now to FIG. 5, a plurality of air filters 502a, 502b, 502c, 502d, 502e, 502f, 502g, 502h can be disposed inside each of the modular housing unit. The air filters can help in cleaning. The air filters may have to be replaced from time to time when they saturate because of perfume molecules or air pollutants. It is also possible to use electro chemical filters whose action can be restored, for example, when a voltage is applied or a chemical agent is added. Alternately the air filters can be placed on a separate plane from the modular housing unit. It is also possible to dispose an air pump system behind the modular housing unit to replace the scenting air with fresh one.

Referring now to FIG. 6, a presence sensor 602 can be disposed on each of the modular housing unit, the presence sensor configured to detect the presence of a person;

a proximity sensor 604 can be disposed on each of the modular housing unit, the proximity sensor configured to estimate the distance between the fragrance apparatus and the person; and

the plurality of control units 106a, 106b, 106c can be further adapted to generate the spatio-temporal pattern of substantially broad spectrum of fragrance if the estimated distance is less than a predetermined value. As an illustrative example, the fragrance apparatus can be configured to deliver perfumes only if the distance between the person and the fragrance apparatus is between 10 nm and 2000 nm. This can optimize the use of the fragrance apparatus and save on perfume. Further, it can help in creating the desired fragrance atmosphere only when required.

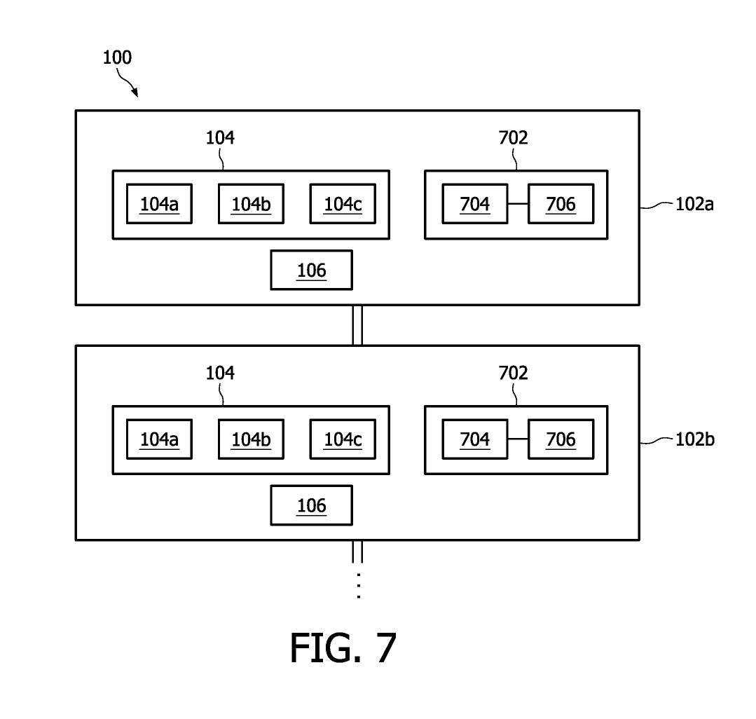

Referring now to FIG. 7, at least one lighting unit 702 can be disposed on each of the modular housing unit, the at least one lighting unit comprising at least one light source 704 controllable by a processor 706 for generating radiation of one or more color and/or one or more brightness levels. The plurality of control units 106a, 106b, 106c can be further adapted to generate a spatio-temporal correlation between light patterns and fragrances.

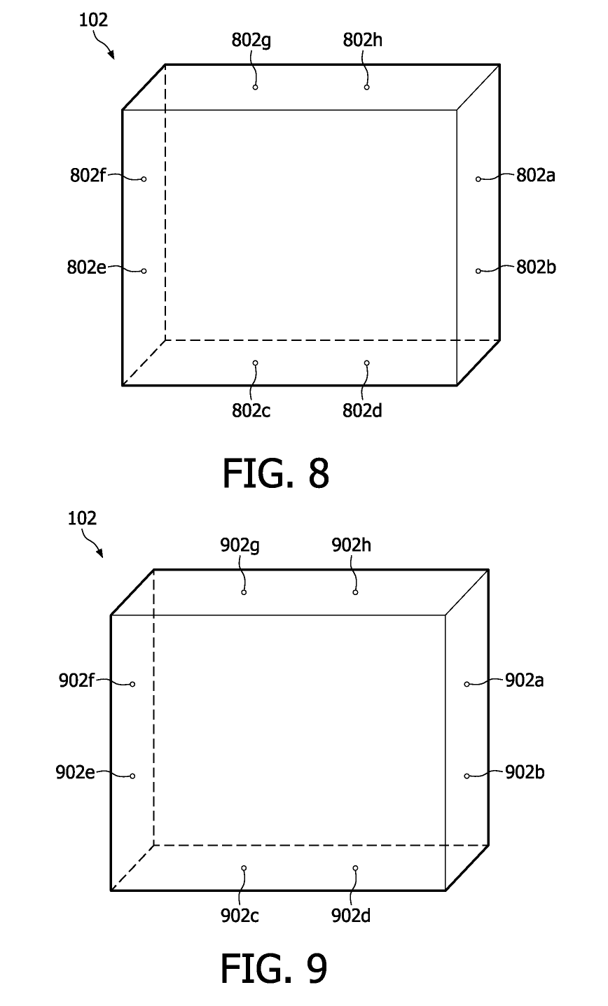

Referring now to FIG. 8, a plurality of photo sensors 802a, 802b, 802c, 802d, 802e, 802f, 802g, 802h can be disposed on each of the modular housing unit configured to detect the level of ambient light in the vicinity of the fragrance apparatus. The plurality of control units 106a, 106b, 106c can be further adapted to generate the spatio-temporal correlation between light patterns and fragrances based on the detected level of the ambient light. As an illustrative example, lighting and aroma of a meeting room can be adjusted to present an environment conducive to a particular meeting objective. For example, if a negotiating meeting is planned, the room's color can be set to blue, and an aromatic mix of chamomile, lavender and sage can be generated throughout the room. On the other hand, if a decision-making meeting is planned, the room's color can be set to red, and an aromatic mix of lemon, rosemary and cedar can be provided. Alternately, if an idea-forming meeting is planned, the room's color can be set to yellow, and an aromatic mix of bergamot, orange and rosewood can be provided.

Referring now to FIG. 9, a plurality of color sensors 902a, 902b, 902c, 902d, 902e, 902f, 902g, 902h can be disposed on each of the modular housing unit configured to detect a plurality of colors and/or a combination of colors and distinguish the detected plurality of colors. The plurality of control units 106a, 106b, 106c can be further adapted to generate the spatio-temporal correlation between light patterns and fragrances based on the detected plurality of colors and/or the combination of the detected colors.

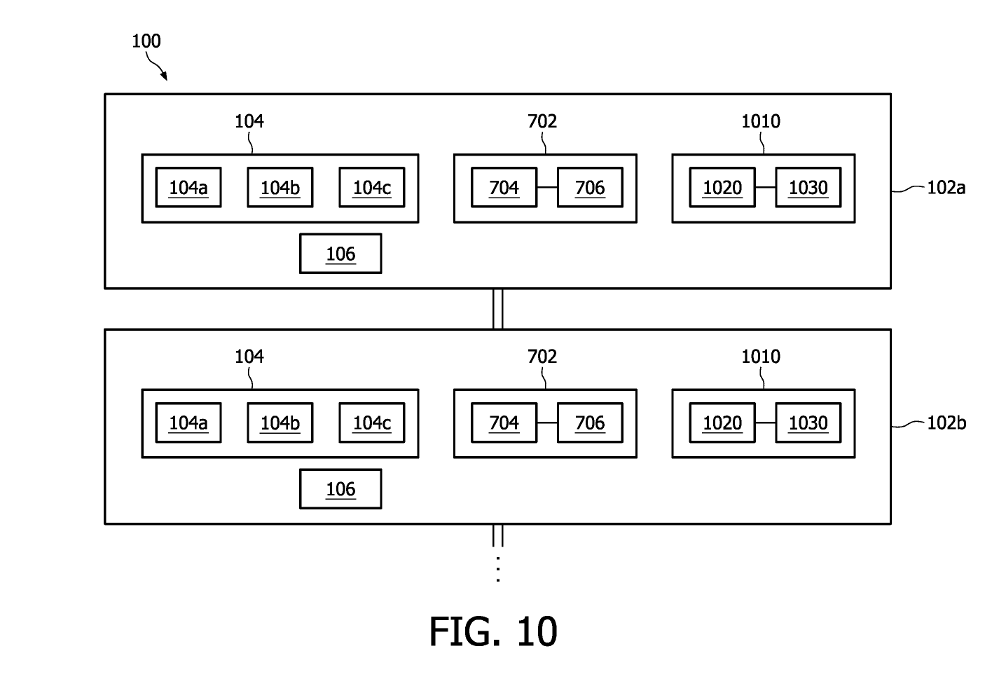

Referring now to FIG. 10, at least one acoustic generator unit 1010 can be disposed on each of the modular housing unit, the at least one acoustic generator unit comprising at least one acoustic source 1020 controllable by a processor 1030 for generating sound. Further, the plurality of control units 106a, 106b, 106c can be further adapted to generate a spatio-temporal correlation between light patterns, sound and fragrances.

It is also possible to provide at least one acoustic sensor disposed on each of the modular housing unit. The acoustic sensors can be configured to detect a plurality of sounds and/or a combination of sounds and distinguish the detected plurality of sounds and/or the combination of detected sounds. Further, the plurality of control units can be adapted to generate the spatio-temporal correlation between light patterns, fragrances and sound based on the detected plurality of sounds and/or the combination of detected sounds.

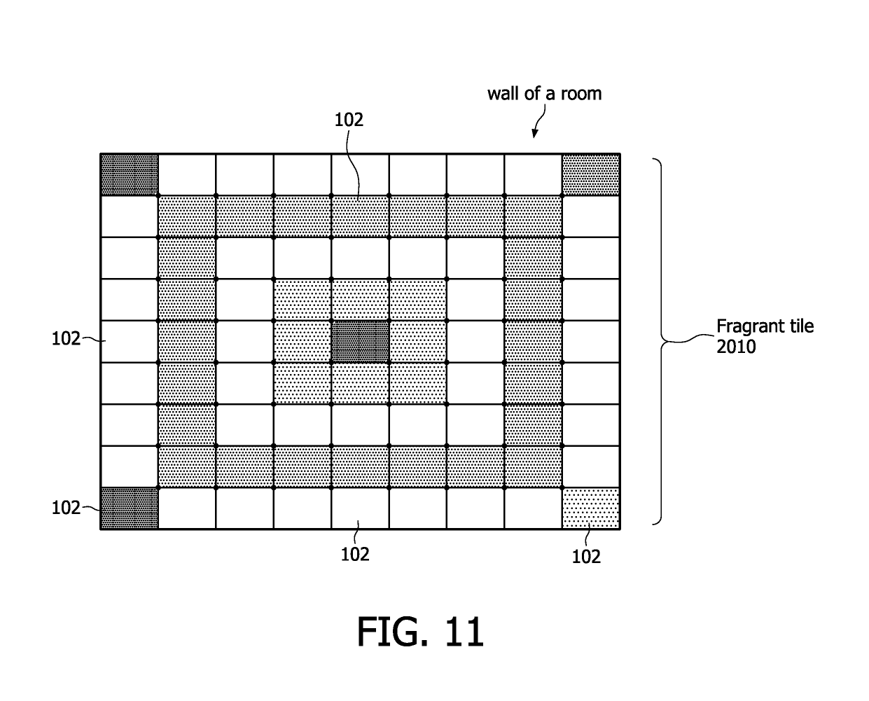

Referring now to FIG. 11, the plurality of modular housing units 102a, 102b, 102c can preferably be square/rectangle in shape and can be put together to form a fragrant tile 2010, the fragrant tile being disposed on the wall of an enclosed area, preferably a room. The plurality of control units 106a, 106b, 106c can be configured to communicate with each other (using wired or wireless communication), exchange data with each other (using known communication protocols) and operate in mutual synchronization to generate a spatio-temporal fragrance image of an object along the wall (example image of a flower) of the room in combination with sound patterns.

In general, the prior art of configuring the fragrance dispensers including peizo-electrically actuated atomization devices, evaporation devices, thermally assisted evaporation devices can be consulted. Further, the components of the control unit for controlling the emission of light, sound and fragrance can be configured to work in a number of ways using the known prior art techniques. The known prior art techniques of configuring the control unit, fragrance dispensers and other hardware units can be consulted to provide examples of how to incorporate them into the disclosed fragrance apparatus.

In summary, a fragrance apparatus comprising a fragrance dispensing unit having a plurality of fragrance dispensers being refillable, the fragrance dispensing unit being disposed in a modular housing unit and a control unit disposed in the modular housing unit, the control unit configured to control the fragrance apparatus such that the fragrance dispensing unit generates a spatio-temporal pattern of fragrance and/or removes the generated spatio-temporal pattern of fragrance is disclosed. The disclosed fragrance apparatus is useful in atmosphere creation.

The fragrance apparatus can be provided as a networked system in which a plurality of modular housing units including fragrance dispensers, light sources and acoustical generators can be controlled to produce a spatio-temporal correlation between light patterns, sound and fragrances. The networked system can have inbuilt intelligence. As an example, if one of the modular housing units fail, or is faulty, then the control unit can select another modular housing unit to exchange data and deliver the fragrance. The communication among the plurality of control units can be wired or wireless using available communication protocols. The disclosed subject matter can also be embodied in a single fragrance apparatus that can emit various combinations of light, fragrance and sound. The disclosed subject matter allows controlling the ambient atmosphere of the environment in which the user of the fragrance apparatus is present.

The present subject matter can be used in

i. cinema halls

ii. home multimedia centers

iii. home shopping centers

iv. interactive advertising

v. hotels to provide personalized room service to guests

vi. advertising on point of sale information

vii. textile, leather and other showrooms

viii. creating bedroom settings

Although claims have been formulated in this application to particular combinations of features, it should be understood that the scope of the disclosure of the present subject matter also includes any novel features or any novel combination of features disclosed herein either explicitly or implicitly or any generalization thereof, whether or not is relates to the same subject matter as presently claimed in any claim and whether or not it mitigates any or all of the same technical problems as does the present subject matter.

Further, while the subject matter has been illustrated in detail in the drawings and foregoing description, such illustration and description are to be considered illustrative or exemplary and not restrictive; the subject matter is not limited to the disclosed embodiments. Other variations to the disclosed embodiments can be understood and effected by those skilled in the art of practicing the claimed subject matter, from a study of the drawings, the disclosure and the appended claims. As an example, the disclosed fragrance apparatus can be integrated with existing products such as televisions and computer monitors. As an illustration, the fragrance apparatus can be disposed on the periphery of the television screen and can be configured to generate a spatio-temporal pattern of fragrance based on the broadcast contents. It is also possible to integrate the disclosed fragrance apparatus into the display unit of a computer monitor. The fragrance apparatus can be configured to generate a spatio-temporal pattern of fragrance based on the contents of the display e.g. contents of an email message. Further, a single unit may fulfill the functions of several items recited in the claims. The mere fact that certain measures are recited in mutually different dependent claims does not indicate that a combination of these measures cannot be used to advantage.

Use of the verb “comprise” and its conjugates does not exclude the presence of elements other than those stated in a claim or in the description. Use of the indefinite article “a” or “an” preceding an element or step does not exclude the presence of a plurality of such elements or steps. The figures and description are to be regarded as illustrative only and do not limit the subject matter. Any reference sign in the claims should not be construed as limiting the scope.

1. A fragrance apparatus comprising
a fragrance dispensing unit having a plurality of fragrance dispensers being refillable, the fragrance dispensing unit being disposed in a modular housing unit; and
a control unit disposed in the modular housing unit, the control unit configured to control the fragrance apparatus such that the fragrance dispensing unit generates a spatio-temporal pattern of fragrance and/or removes the generated spatio-temporal pattern of fragrance.

2. The fragrance apparatus as claimed in claim 1, wherein a plurality of modular housing units are operatively interconnected and configured such that the plurality of control units communicate with each other, exchange data with each other and operate in mutual synchronization to generate a spatio-temporal pattern of substantially broad spectrum of fragrances.

3. The fragrance apparatus as claimed in claim 2, wherein in operation a state of a first modular housing unit depends on a state of at least one second modular housing unit, the state being the state of the control unit.

4. The fragrance apparatus as claimed in claim 3, wherein micro-holes are disposed preferably on the front plane, the back plane and the side plane of each of the modular housing unit.

5. The fragrance apparatus as claimed in claim 2, wherein the plurality of modular housing units are operatively interconnected such that the plurality of control units cooperate under control of a central controller or a computer, communicate with the central controller, operate in mutual synchronization to generate the spatio-temporal pattern of substantially broad spectrum of fragrances.

6. The fragrance apparatus as claimed in claim 5, further comprising
a presence sensor disposed on each of the modular housing unit, the presence sensor configured to detect the presence of a person;
a proximity sensor disposed on each of the modular housing unit, the proximity sensor configured to estimate the distance between the fragrance apparatus and the person; and
the plurality of control units further adapted to generate the spatio-temporal pattern of substantially broad spectrum of fragrance if the estimated distance is less than a predetermined value.

7. The fragrance apparatus as claimed in claim 6, further comprising
at least one lighting unit disposed on each of the modular housing unit, the at least one lighting unit comprising at least one light source controllable by a processor for generating radiation of one or more color and/or one or more brightness levels; and
the plurality of control units further adapted to generate a spatio-temporal correlation between light patterns and fragrances.

8. The fragrance apparatus as claimed in claim 7, further comprising
a plurality of photo sensors disposed on each of the modular housing unit configured to detect the level of ambient light in the vicinity of the fragrance apparatus; and
the plurality of control units further adapted to generate the spatio-temporal correlation between light patterns and fragrances based on the detected level of the ambient light.

9. The fragrance apparatus as claimed in claim 8, further comprising
a plurality of color sensors disposed on each of the modular housing unit configured to detect a plurality of colors and/or a combination of colors and distinguish the detected plurality of colors; and
the plurality of control units further adapted to generate the spatio-temporal correlation between light patterns and fragrances based on the detected plurality of colors and/or the combination of the detected colors.

10. The fragrance apparatus as claimed in claim 9, wherein in operation a state of a first modular housing unit depends on a state of at least one second modular housing unit, the state being the state of the control unit representing a combination of fragrance and light.

11. The fragrance apparatus as claimed in claim 10, further comprising
at least one acoustic generator unit disposed on each of the modular housing unit, the at least one acoustic generator unit comprising at least one acoustic source controllable by a processor for generating sound; and
the plurality of control units further adapted to generate a spatio-temporal correlation between light patterns, sound and fragrances.

12. The fragrance apparatus as claimed in claim 11, wherein in operation a state of a first modular housing unit depends on a state of at least one second modular housing unit, the state being the state of the control unit representing a combination of fragrance, light and sound.

13. The fragrance apparatus as claimed in claim 12, wherein the plurality of modular housing units are preferably square/rectangle in shape and are put together to form a fragrant tile, the fragrant tile being disposed on the wall of an enclosed area, preferably a room.

14. The fragrance apparatus as claimed in claim 13, wherein the plurality of control units communicate with each other, exchange data with each other and operate in mutual synchronization to generate a spatio-temporal fragrance image of an object along the wall of the room in combination with sound patterns.

15. Software program comprising an executable code for controlling the fragrance apparatus as claimed in claim 1, wherein controlling comprises controlling the fragrance apparatus such that the fragrance dispensing unit generates a spatio-temporal pattern of fragrance and/or removes the generated spatio-temporal pattern of fragrance.
